(19) United States
(12) Patent Application Publication
(10) Pub. No.: US 2013/0142358 A1
(43) Pub. Date: Jun. 6, 2013

(54) Variable Directivity MEMS Microphone

(71) Applicant: Knowles Electronics, LLC, Itasca, IL (US)

(72) Inventors: Jordran T. Schultz, Chicago, IL (US); Thomas E. Miller, Arlington Heights, IL (US)

(73) Assignee: Knowles Electronics, LLC, Itasca, IL (US)

(21) Appl. No.: 13/705,762

(22) Filed: Dec. 5, 2012

Related U.S. Application Data
(60) Provisional application No. 61/567,219, filed on Dec. 6, 2011.

(51) Int. Cl. H04R 1/32

(52) U.S. Cl. CPC H04R 1/326
USPC 381/92

(57) ABSTRACT

The directivity pattern of a MEMS microphone is adjusted. An indication of a position of a MEMS microphone is received and the microphone includes at least one diaphragm. An adjustment to the position of the MEMS microphone is determined. Based upon the adjustment, a position of the at least one diaphragm is adjusted. The adjusting is effective to alter a directivity pattern of the microphone.

### CROSS REFERENCE TO RELATED APPLICATIONS

This patent claims benefit under 35 U.S.C. §119 (e) to U.S. Provisional Application No. 61/567,219 entitled “Variable Directivity MEMS Microphone” filed Dec. 6, 2011, the content of which is incorporated herein by reference in its entirety.

### TECHNICAL FIELD

This application relates to acoustic devices and, more specifically, to microphones, and their directivity patterns.

### BACKGROUND OF THE INVENTION

Various types of microphones have been used through the years. In these devices, different electrical components are housed together within a housing or assembly. For example, a microphone typically includes a diaphragm and a back plate (among other components) and these components are disposed together within a housing. Other types of acoustic devices such as receivers may include other types of components.

A microphone has a directivity or directionality pattern that defines and describes the sensitivity of the microphone to sound depending upon the direction from which the sound is received. A unidirectional directivity pattern, for instance, provides that the microphone responds to signals in one direction. On the other hand, an omni-directional directivity pattern indicates that the microphone responds to sound from all directions.

Microelectromechanical system (MEMS) microphones are used in a variety of different devices. For example, these microphones may be used in cellular phones, hearing aids, computers, to mention a few examples. Other examples of devices are possible. Previous MEMS microphones have a preset directionality or directivity response that is built into the microphone.

Unfortunately, the most desirable directivity pattern for a particular MEMS microphone that is disposed in a device often changes over time. For example, the microphone in a cellular phone may be positioned in a first manner (e.g., where the cellular phone is positioned upright) in one situation but positioned differently (e.g., where the cellular phone is lying flat) in another situation.

This permanence in the directivity pattern of MEMS microphones has led to problems. For example, in some microphone dispositions, sound cannot be picked up very well and sometimes not at all. As a result, as a device is moved through different positions, the received sound quality will vary due to background interference or inability to pick up directional sound sources. Consequently, general user dissatisfaction has resulted with previous approaches.

### BRIEF DESCRIPTION OF THE DRAWINGS

For a more complete understanding of the disclosure, reference should be made to the following detailed description and accompanying drawings wherein:

FIG. 1 comprises a block diagram of an apparatus for dynamically adjusting the directivity pattern of a microphone according to various embodiments of the present invention;

FIG. 2 comprises a block diagram of an apparatus for dynamically adjusting the directivity pattern of a microphone according to various embodiments of the present invention;

FIG. 3A comprises a block diagram of a dual diaphragm microphone or motor according to various embodiments of the present invention;

FIG. 3B comprises a block diagram of the operation of the microphone or motor of FIG. 3A according to various embodiments of the present invention;

FIG. 3C comprises a block diagram of the operation of the microphone or motor of FIG. 3A according to various embodiments of the present invention;

FIG. 3D comprises a block diagram of the operation of the microphone or motor of FIG. 3A according to various embodiments of the present invention;

FIG. 4 comprises a flowchart showing an approach for dynamically changing the directivity pattern associated with a microphone according to various embodiments of the present invention;

FIG. 5 comprises a block diagram showing one example of an apparatus for dynamically adjusting the directivity pattern of a microphone disposed in an electronic device according to various embodiments of the present invention;

FIG. 6 comprises a block diagram showing another example of an apparatus for dynamically adjusting the directivity pattern of a microphone disposed in an electronic device according to various embodiments of the present invention;

FIG. 7 comprises a block diagram showing still another example of an apparatus for dynamically adjusting the directivity pattern of a microphone disposed in an electronic device according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Microelectromechanical (MEMS) microphones having dynamically adjustable directivity patterns are provided. The directivity pattern of the microphone is changed automatically (without a user providing any intervention or input to the device). In so doing, the most desirable directivity pattern can be provided for the MEMS microphone no matter the disposition and positioning of the electronic device in which the MEMS microphone resides.

In many of these embodiments, a variable-directional MEMS microphone is coupled to an accelerometer or other sensor. In one aspect, a microphone is in a Braunmuhl-Weber configuration. The directivity pattern of reception for the microphone is dynamically and automatically changed based upon the output of an accelerometer or sensor. In one example, the accelerometer output is sent to an integrated circuit (e.g., an application specific integrated circuit (ASIC) or some other processing device). The voltage applied to one or more of the diaphragms is changed depending upon the output of the accelerometer and this alteration of voltage changes the sensitivity pattern of the microphone.

In others of these embodiments, the directivity pattern of a MEMS microphone is adjusted. An indication of a position of a MEMS microphone is received and the microphone includes at least one diaphragm. An adjustment to the position of the MEMS microphone is determined. Based upon the adjustment, a position of the at least one diaphragm is adjusted. The adjusting is effective to alter a directivity pattern of the microphone.

In some aspects, a look-up table is utilized to determine the adjustment. In other aspects, the at last one diaphragm includes a first diaphragm and a second diaphragm. Adjustments to the position are made by adjusting one or more of the first diaphragm or the second diaphragm.

In some examples, the adjustment comprises a voltage adjustment. The microphone may be disposed in a device such as a personal computer and a cellular phone. Other examples of devices are possible.

The directivity pattern may be a pattern such as an omni-directional pattern, a bi-directional pattern, a cardoid pattern, or a hyper-cardoid pattern. Other examples of patterns are possible.

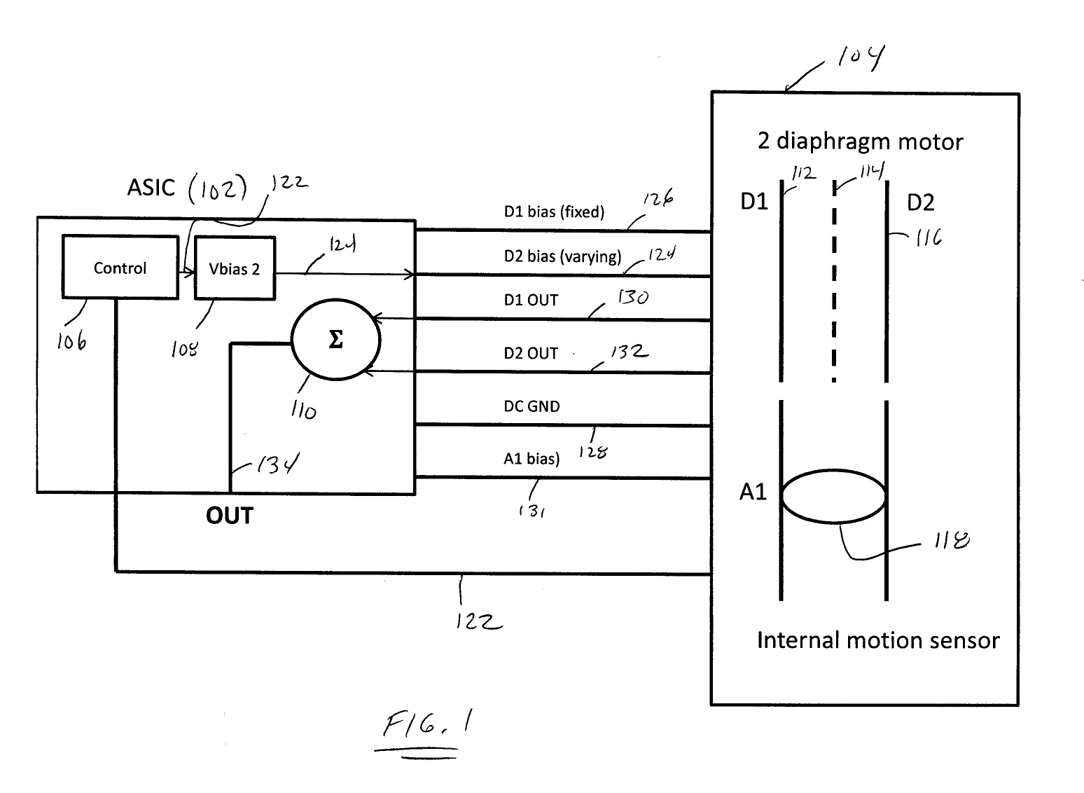

Referring now to FIG. 1, one example of an apparatus for dynamically and automatically changing the directivity pattern of a microphone or motor is described. As used herein, “motor” refers to a microphone that converts sound energy into an electrical signal. The system includes an ASIC 102 and a two diaphragm motor 104. The ASIC 102 includes a control apparatus 106, a V_{BIAS} element 108, and a summer 110. The motor 104 includes a first diaphragm 112 (D1), a perforated conducting plate 114, a second diaphragm 116, and an internal motion sensor 118.

The ASIC 102 can be any type of analog and/or digital integrated circuit. The control apparatus 106 of the ASIC 102 is configured to receive signals from the sensor 118 and output a control signal to the V_{BIAS} element 108. The V_{BIAS} element 108 is a controllable voltage source. The summer 110 adds output voltages received from the first diaphragm 112 and the second diaphragm 116.

A control line 122 communicates between the sensor 118 and the control apparatus 106. The V_{BIAS} element transmits a signal 124 to one of the diaphragms 112 or 116. A separate DC voltage 126 is applied to the other diaphragm. A DC ground connection 128 is provided to both the back plate 114 and the ASIC 102. The motor 104 provides a first output signal 130 from the first diaphragm 112 and second output signal 132 from the second diaphragm 116 to the summer 110. The summer 110 adds these signals together and provides an output 134 of the ASIC 102. A line 131 provides a DV bias to the sensor 118 if necessary for it to function.

In one example of the operation of the system of FIG. 1, the system is disposed at or in a device such as a cellular phone or a personal computer. The sensor 118 detects a position of the microphone/motor 104 and sends a signal via control line 122 to the control apparatus 106. The signal represents the position (e.g., upright) of the microphone 104. The control apparatus 106 processes the signal and determines if the output voltage provided by the V_{BIAS} element 108 should be adjusted. For instance, a look-up table may be provided that has as one entry the voltage provided by the line 122 with the corresponding table entry being the corresponding voltage adjustment.

After being controlled by control apparatus 106, the V_{BIAS} element 108 provides a DC bias based upon the received control signal 122 to the diaphragm 116. A separate DC bias 126 is provided to the other diaphragm and this is a fixed signal. In alternate embodiments, both diaphragms may have adjustable bias levels. Responsively, the motor 104 provides a first output signal 130 from the first diaphragm 112 and second output signal 132 from the second diaphragm 116 to the summer 110. The voltage adjustment causes the diaphragms in the motor to deflect in certain ways thereby operating the motor 104 according to a predetermined directivity pattern. The summer 110 adds the signals together and provides an output 134 of the ASIC 102.

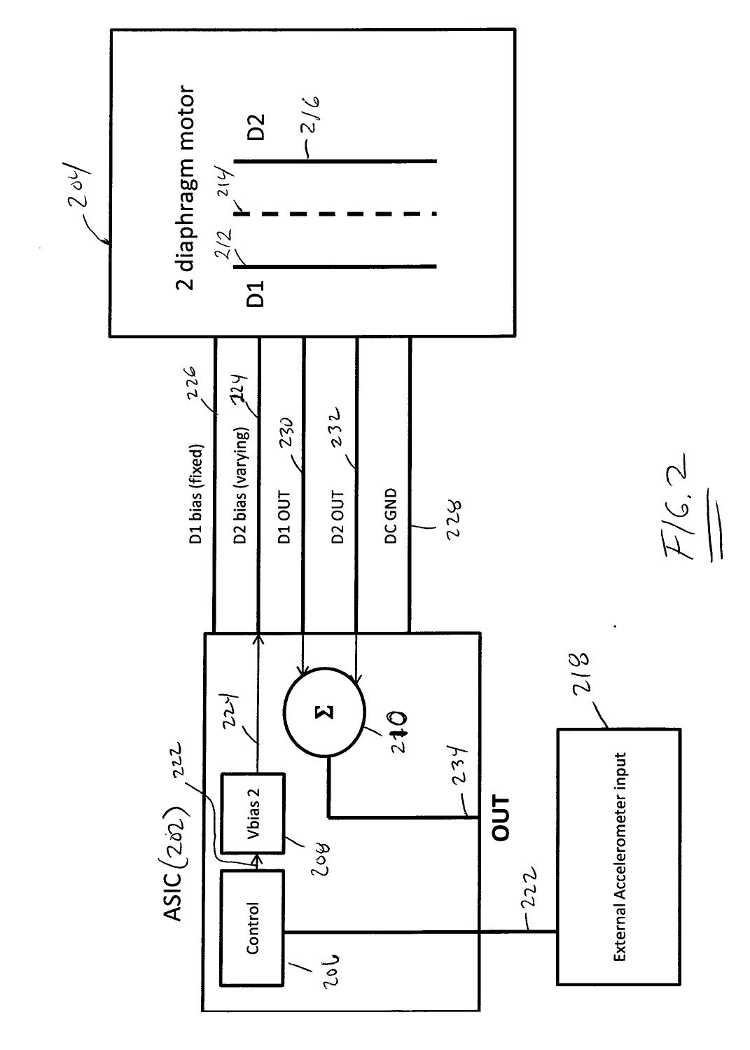

Referring now to FIG. 2, another example of an apparatus for adjusting the directivity pattern of a microphone is described. The system includes an ASIC 202 and a two diaphragm motor 204. The ASIC 202 includes a control apparatus 206, a V_{BIAS} element 208, and a summer 210. The motor 204 includes a first diaphragm 212 (D1), a charge plate 214, and a second diaphragm 216. An external accelerometer 218 is coupled to the control apparatus 206 via a control line 222.

The V_{BIAS} element 208 provides a DC bias 224 to the diaphragm 216. A fixed DC bias 226 is provided to the other diaphragm. In this example, this is a fixed signal. A DC ground connection 228 is provided to both the motor 204 and the ASIC 202. The motor 204 provides a first out put signal 230 from the first diaphragm 212 and second output signal 232 from the second diaphragm 216 to the summer 210. The summer 210 adds these signals together and provides an output 234 of the ASIC 202.

The elements of FIG. 2 are similar to the elements described with respect to FIG. 1 and their descriptions will not be repeated here. The operation of the system of FIG. 2 is also similar to the operation of the system of FIG. 1 (except the sensor is not a part of the motor) and will not be repeated here.

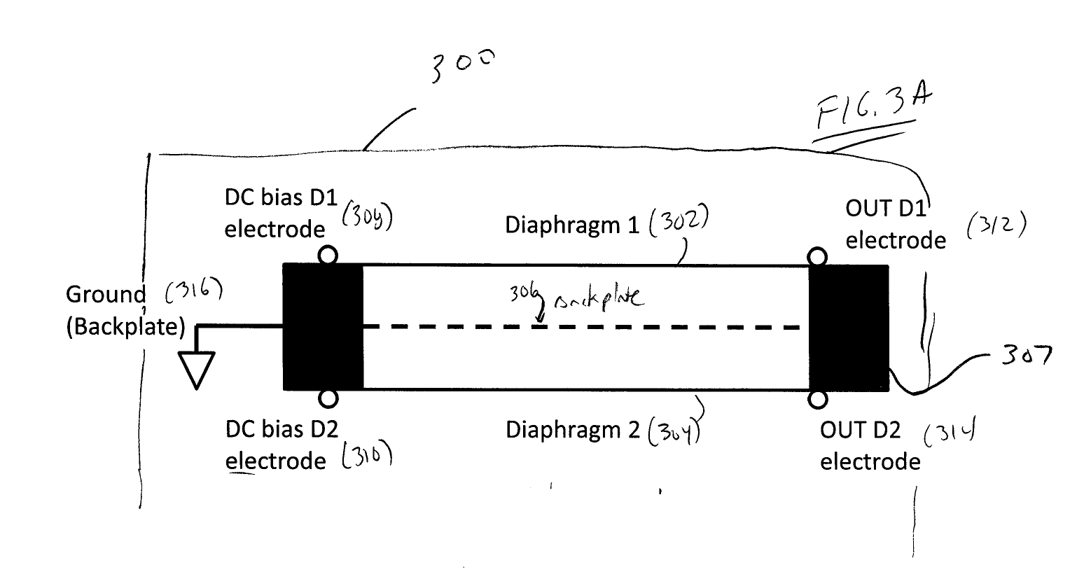

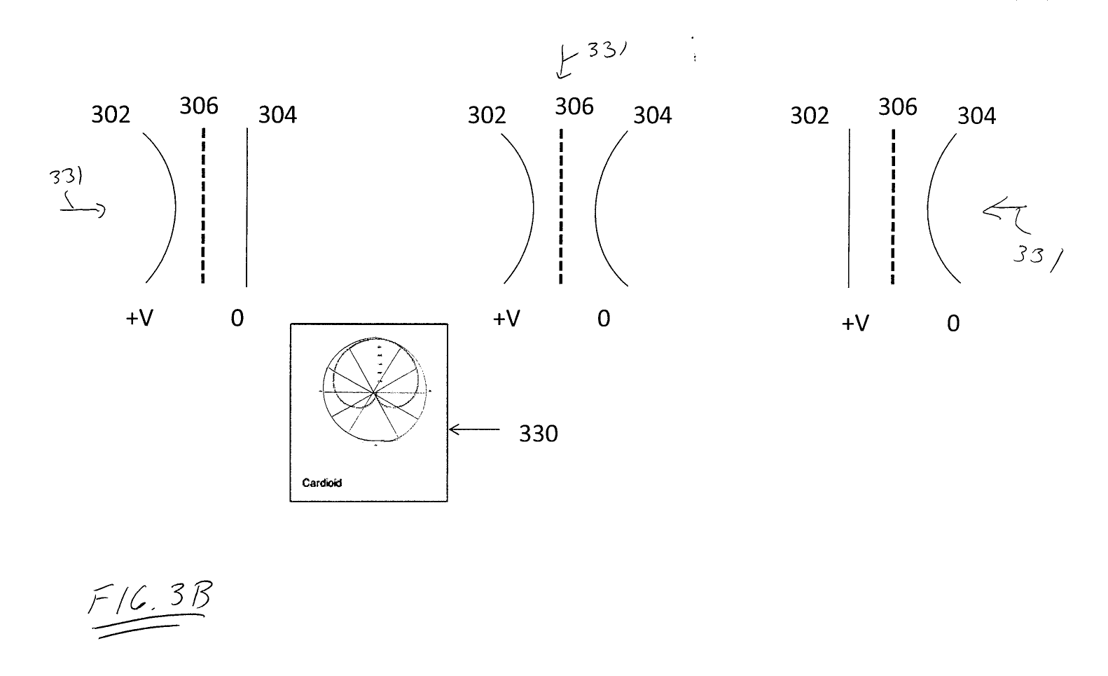

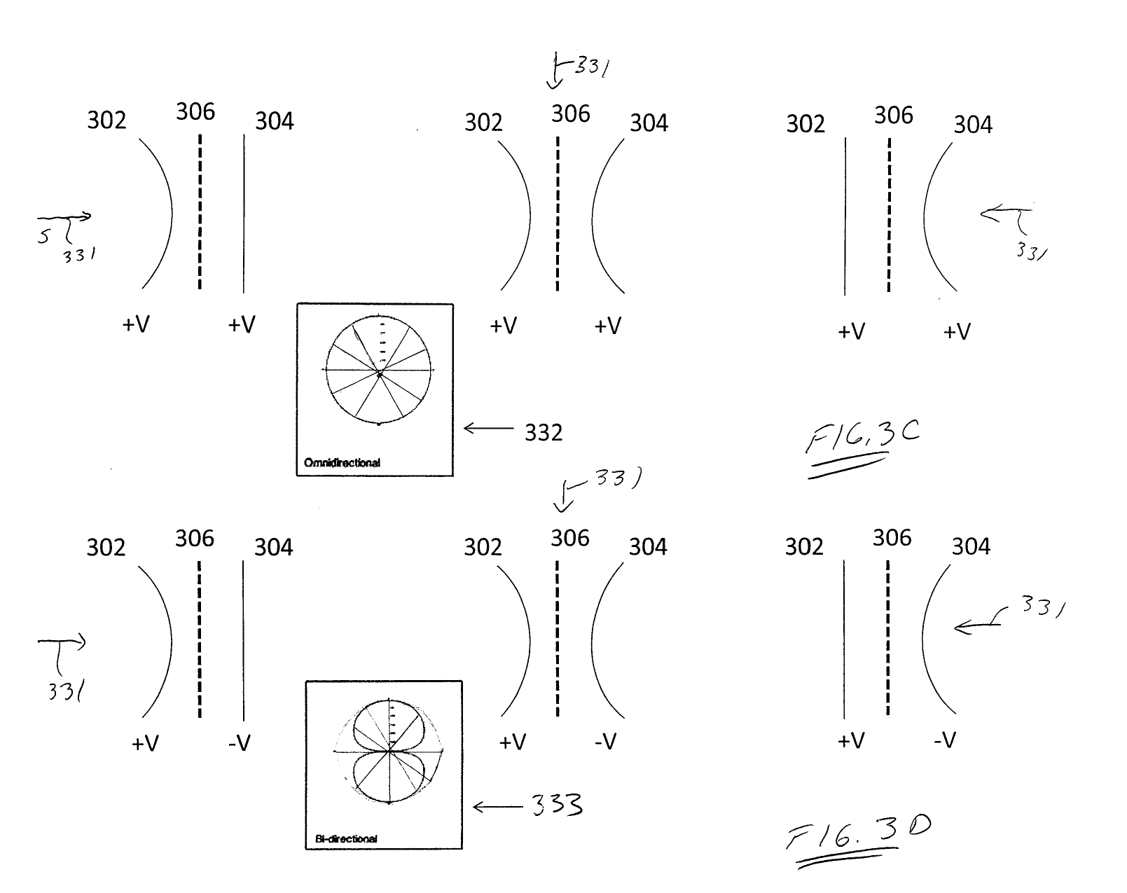

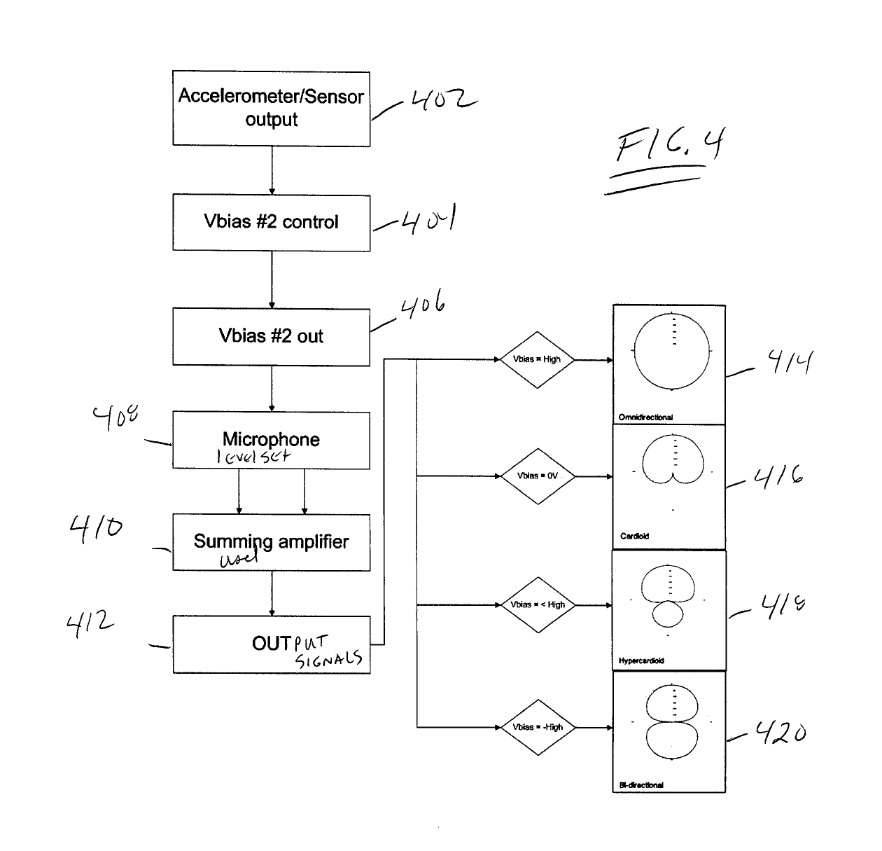

Referring now to FIG. 3A, an example of a microphone 300 as used in the two diaphragm motor is described. The microphone 300 includes a first diaphragm 302, a second diaphragm 304, a back plate 306, a first DC bias (D1) electrode 308, a second DC bias (D2) electrode 310, a first output electrode OUT (D1) 312, a second output electrode OUT (D2) 314, and a ground connection 316 for the back plate 306. The diaphragms 302 and 304 are disposed at MEMS structure 307.

In the example of FIG. 3B, a +V is applied to the first diaphragm and 0 V is applied to the second diaphragm to obtain a cardioid directivity pattern 330. In the example of FIG. 3C, a +V is applied to the first diaphragm and a +V is applied to the second diaphragm to obtain an omnidirectional directivity pattern 332. In the example of FIG. 3D, a +V is applied to the first diaphragm and a −V is applied to the second diaphragm to obtain a bi-directional directivity pattern 333. In all of these examples, sound energy is indicated by the arrows labeled 331. It can be seen that the directivity pattern of the microphone is changed based upon the voltages applied to the diaphragms.

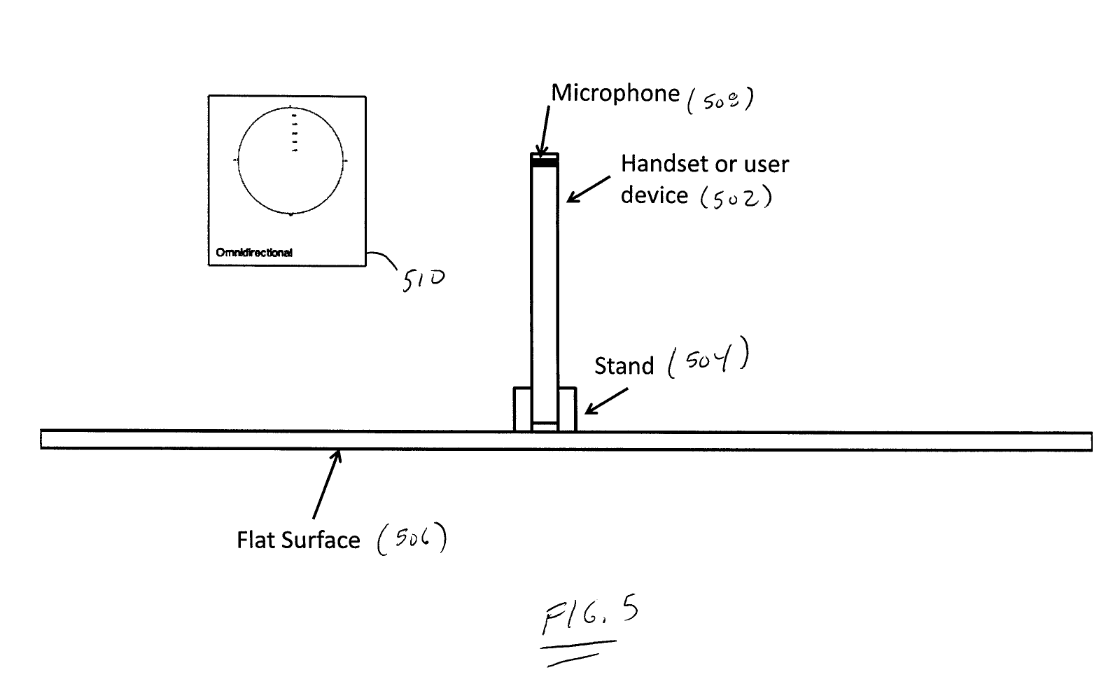

Referring now to FIG. 4, a flowchart showing approaches for operating an internal tilt motor is described. In this example, the apparatus shown in FIG. 1, FIG. 2, or FIG. 3 can be used. At step 402, an accelerometer or sensor output is obtained. In one example, this is a voltage that represents the position of the microphone (e.g., upright, lying flat, and so forth) and this indicates the position of the device.

At step 404, the controller determines the level to adjust the V_{BIAS} control. In one aspect, the accelerometer input provides the index to a look-up table. The look-up table entry provides the adjustment to the V_{BIAS} control. At step 406, the V_{BIAS} output level is set and the voltage provided by V_{BIAS} is sent to the microphone/motor.

At step 408, the V_{BIAS} level is set at the diaphragm. More specifically, one or both of the diaphragms have their voltage levels set depending upon the desired directivity pattern. This adjustment of the voltage bias to one or more of the diaphragms has the effect of changing the directivity pattern of the microphone.

At step 410, a summing amplifier is used to receive the two signals and add them together. The sum represents the received sound and the sum is needed because the contributions of the two diaphragms should be considered.

At 412, the summed signal from the diaphragms is output from the motor and has a directivity pattern that depends on the level of V_{BIAS}. In one aspect, if both V_{BIAS} terminals are high (e.g., +V), the directivity pattern of the microphone will be an omni-directional pattern 414. If V_{BIAS} is 0 volts, the directivity pattern of the microphone will be a cardoid pattern 416. If V_{BIAS} is some other positive value, then the directivity pattern of the microphone will be a hypercardoid 418. If V_{BIAS} is a negative high value (e.g., −V), the directivity pattern of the microphone will be a bi-directional pattern 420.

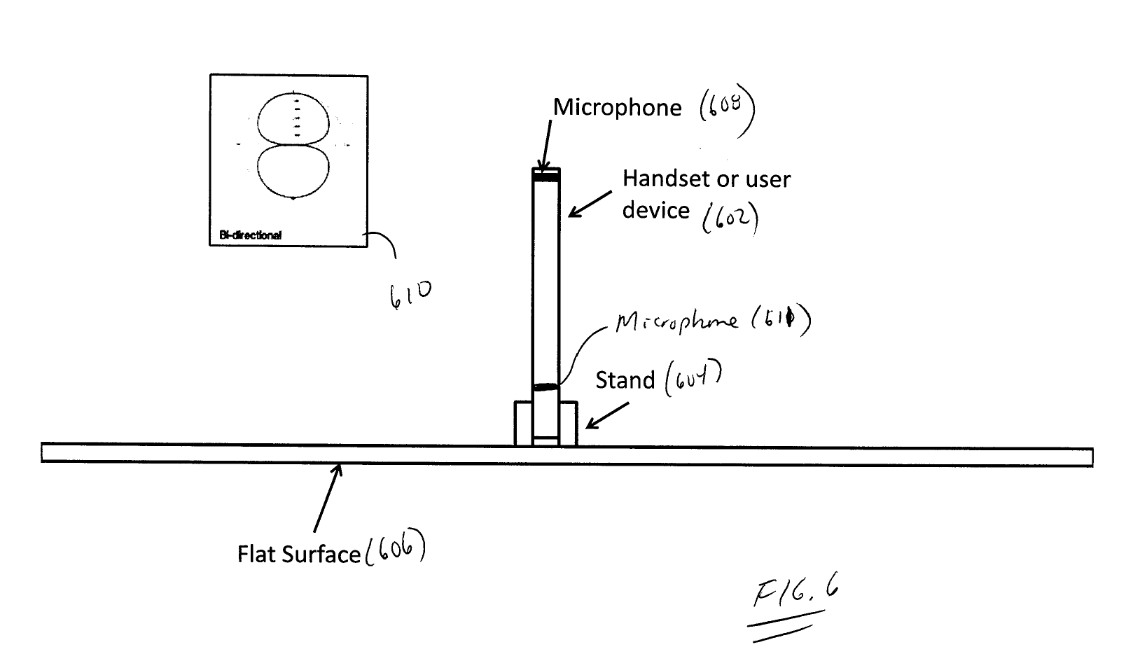

Referring now to FIG. 5, an example of using a microphone in a device is now described. A handset or user device 502 is held by a stand 504 on a flat surface 506. The device 502 includes a MEMS microphone 508. The microphone 508 is constructed according to the approaches described herein (e.g., with two diaphragms). An accelerometer associated with the microphone 508 senses that the device is in the upright position. As a result, according to the approaches described herein the microphone 508 is tuned to receive signals according to an omni-directional pattern 510. To take one example, this pattern may have particular applicability for conferencing with multiple people where the people are sitting, for instance, around a conference table.

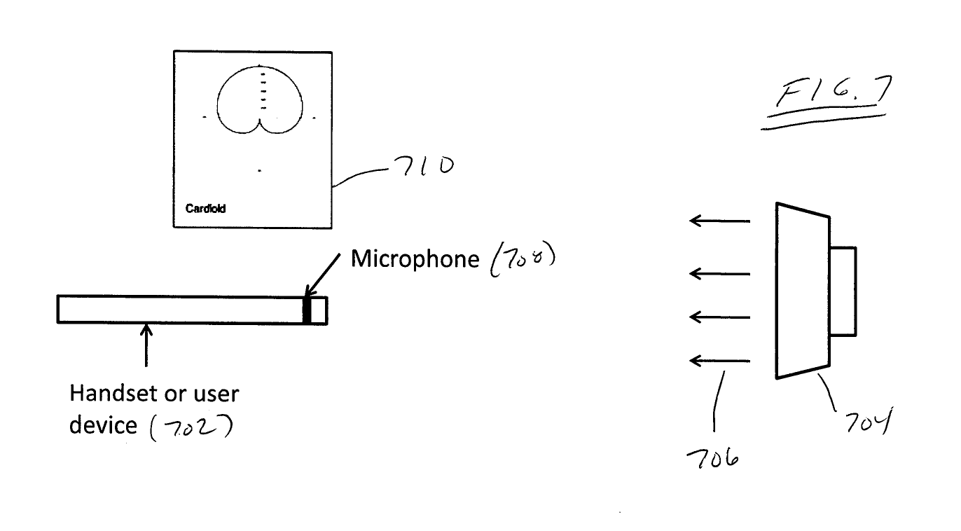

Referring now to FIG. 6, another example of using a microphone in a device is now described. A handset or user device 602 is held by a stand 604 on a flat surface 606. The device 602 includes a first MEMS microphone 608 and a second MEMS microphone 611. The microphones 608 and 611 are constructed according to the approaches described herein (e.g., with two diaphragms). An accelerometer associated with the second (bottom) microphone 611 senses that the device is in the upside down position (i.e., according to the bi-directional directivity pattern). As a result, according to the approaches described herein the microphone 608 is tuned to receive signals according to a bi-directional pattern 610. To take one example, this pattern may have particular applicability for interviews between two people.

Referring now to FIG. 7, yet another example of using a microphone in a particular device is now described. A handset or user device 702 faces a speaker 704, which is emitting sound (e.g., music) 706. The device 702 includes a MEMS microphone 708 and may be held by a hand or tripod to mention two examples. The microphone 708 is constructed according to the approaches described herein (e.g., with two diaphragms). An accelerometer associated with the microphone 708 senses that the device is in a position parallel to the horizontal plane. As a result, according to the approaches described herein the microphone 708 is tuned to receive signals according to a cardoid pattern 710. To take one example, this pattern may have particular applicability for any situation where the microphone needs to be aimed at a particular target location (e.g., for recording music from a speaker in a noisy environment).

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A method of adjusting the directivity pattern of a MEMS microphone, the method comprising:
receiving an indication of a position of a MEMS microphone, the microphone including at least one diaphragm;
determining adjustment to the position of the MEMS microphone;
based upon the determined adjustment, adjusting a position of the at least one diaphragm, the adjusting being effective to alter a directivity pattern of the microphone.

2. The method of claim 1 wherein determining the adjustment comprises utilizing a look-up table to determine the adjustment.

3. The method of claim 1 wherein the at last one diaphragm comprises a first diaphragm and a second diaphragm.

4. The method of claim 3 wherein adjusting the position comprises adjusting the position of one or more of the first diaphragm or the second diaphragm.

5. The method of claim 1 wherein the adjustment comprises a voltage adjustment.

6. The method of claim 1 wherein the microphone is disposed in a device selected from the group consisting of a personal computer and a cellular phone.

7. The method of claim 1 wherein the directivity pattern is a pattern selected from the group consisting of an omni-directional pattern, a bi-directional pattern, a cardoid pattern and a hyper-cardoid pattern.

8. A system comprising:
a variable-directional MEMS microphone having a diaphragm;
a sensor coupled to the microphone having an output; and
wherein the output of the sensor is applied to the diaphragm, the application being effective to dynamically and automatically alter the directivity pattern of reception for the microphone.

9. The system of claim 8 wherein the microphone comprises a Braunmuhl-Weber configuration.

10. The system of claim 8 wherein the sensor comprises an accelerometer.
